(19) United States
(12) Patent Application Publication
(10) Pub. No.: US 2025/0389922 A1
(43) Pub. Date: Dec. 25, 2025

(54) CARRIER FOR PULLING OPTICAL CABLE

(71) Applicant: viaPhoton, Inc., Aurora, IL (US)

(72) Inventor: Keith Samuel MARANTO, Frankfort, IL (US)

(21) Appl. No.: 19/246,438

(22) Filed: Jun. 23, 2025

Related U.S. Application Data
(60) Provisional application No. 63/663,175, filed on Jun. 23, 2024.

(51) Int. Cl. G02B 6/54

(52) U.S. Cl. CPC G02B 6/545

(57) ABSTRACT

A carrier system for pulling a cable includes a tubular housing having an elongate body with a non-uniform cross-section, a tapered first end, and an open second end. A carriage is releasably secured to the second end and includes a plug configured to seal the housing during pulling. The plug may be a clamshell structure with an aperture sized to receive a cable of an optical connector, enabling axial retention and environmental sealing. The apparatus further includes an optical connector with a cable extending through the plug. A method for using the carrier includes securing the optical connector within the tubular housing, attaching the carriage to the open end, and pulling the carrier through a conduit. The housing geometry is modulated along its length for improved conduit navigation and strain distribution. The carriage assembly provides protection and sealing for the connector and supports deployment of pre-terminated cables in buried environments.

### CROSS-REFERENCE TO RELATED APPLICATIONS

This Application claims the benefit of U.S. Provisional Application Ser. No. 63/663,175, filed Jun. 23, 2024, which is hereby incorporated by reference for all purposes.

### BACKGROUND

The deployment of fiber optic infrastructure in outdoor and underground environments frequently requires the use of pre-terminated optical connectors. These connectors, often installed in controlled manufacturing conditions, are subsequently routed through ducts, conduits, or buried pathways to reach their final installation locations. However, the physical dimensions, rigidity, and sensitivity of such connectors introduce substantial challenges during pulling operations. Excessive mechanical stress or misalignment during installation can damage the connectors, impair optical performance, or require costly field retermination.

To mitigate damage, field technicians often employ improvised or application-specific housings to enclose the connector ends during pulling. These solutions may involve rigid enclosures, flexible sleeves, or temporary protective caps. While such approaches provide some degree of shielding, they frequently fail to accommodate different connector geometries, ensure proper axial alignment, or maintain environmental seals against moisture, dust, or debris. The absence of standardized, reusable carrier solutions has led to inconsistent field practices and increased installation times.

In addition to physical protection, the ability to pull connectors through varying conduit geometries introduces further complications. Conduit profiles may include bends, varying diameters, or surface discontinuities that increase the risk of snagging or connector misalignment. Carriers must therefore present a shape and surface profile that enables smooth translation through these environments while preserving the integrity of the internal cable and connector components. Prior solutions have not adequately addressed the integration of connector support, environmental sealing, and geometric optimization within a single, cohesive assembly.

### SUMMARY

According to a first aspect of the invention, a carrier provided for pulling a cable, the carrier comprising a tubular housing with a non-uniform cross-section. The housing includes an elongate body that is tapered at a first end and open at a second end, with a cross-sectional shape that transitions from circular to super-elliptic along its length. A carriage is releasably secured to the second end of the housing and includes a plug that seals the housing during pulling operations. The tapered first end and variable cross-section enhance insertion and reduce resistance during conduit entry, while the removable carriage enables secure retention of a pre-terminated optical connector and its attached cable.

According to another aspect of the invention, an apparatus includes an optical connector with a cable extending therefrom, combined with a carrier. The carrier includes the same tubular housing and carriage assembly as described in the first claim. The connector is positioned within the elongate housing body, and the cable passes through the carriage, which is configured to provide sealing and strain relief. This apparatus provides an integrated deployment solution wherein the optical interface and mechanical protection are maintained during buried or conduit-based installation.

According to yet another aspect of the invention, a method is provided for pulling cable, comprising the steps of securing an optical connector within a tubular housing, attaching a carriage with a sealing plug to the open end of the housing, and pulling the assembled carrier through an environment. The method encompasses the geometric features of the housing and the mechanical engagement between the carriage and cable, providing a structured process for installing pre-terminated optical cables without damaging the connector interface. The flow of operations supports field deployment with reduced installation time and consistent protective performance.

Other aspects of the invention will be apparent from the following description and the appended claims.

### BRIEF DESCRIPTION OF DRAWINGS

FIG. 1 shows a rack is in accordance with one or more embodiments.

FIG. 2A illustrates a carrier assembly according to one or more illustrative embodiments.

FIG. 2B illustrates an exploded view of the carrier assembly of FIG. 2A, according to one or more illustrative embodiments.

FIG. 3A illustrates a perspective view of the tubular housing, according to one or more illustrative embodiments.

FIG. 3B illustrates various cross-sectional profiles of the elongate body, according to one or more illustrative embodiments.

FIG. 4A illustrates an exploded view of the carriage assembly, according to one or more illustrative embodiments.

FIG. 4B illustrates the clamshell plug of FIG. 4A in an open configuration, according to one or more illustrative embodiments.

FIG. 5 illustrates a flowchart of a method for pulling a cable using the carrier assembly, according to one or more illustrative embodiments.

Like elements in the various figures are denoted by like reference numerals for consistency.

### DETAILED DESCRIPTION

The present invention provides a carrier assembly for pulling optical connectors through buried or constrained pathways, addressing limitations in environmental sealing, mechanical protection, and geometric adaptability. The system includes a tubular housing having a non-uniform cross-section that transitions from a circular profile at the rear to a super-elliptic profile at an intermediate location, terminating in a tapered, hemispherical cap at the front. This shape modulation facilitates smoother conduit entry, reduces pull resistance, and improves strain distribution during pulling. An integrated eyelet extends from the hemispherical cap to enable secure attachment to a tensile pulling element.

A carriage assembly is releasably secured to the open rear of the housing and contains a plug for receiving and sealing around the optical connector and its attached cable. The plug may be implemented as a clamshell body configured to snap around the cable without requiring disconnection or retermination. It includes an axial aperture with at least one compression zone having a diameter smaller than the cable diameter, thereby forming an interference seal. The plug may be used in conjunction with a soft grommet and elastomeric O-ring to provide multi-stage environmental sealing and strain relief. This configuration supports pre-terminated connector deployment while minimizing ingress of water and particulates.

The cross-sectional geometry of the elongate body is defined parametrically to provide a continuous, non-linear modulation between the connector cavity and the tapered head. By controlling the shape parameter nn in the super-elliptic formulation, the housing can be tuned for specific conduit types or installation environments. The modular nature of the carriage further allows for interchangeability across different connector types. These features combine to yield a reusable, standardized deployment mechanism capable of withstanding the mechanical and environmental demands of buried cable installation.

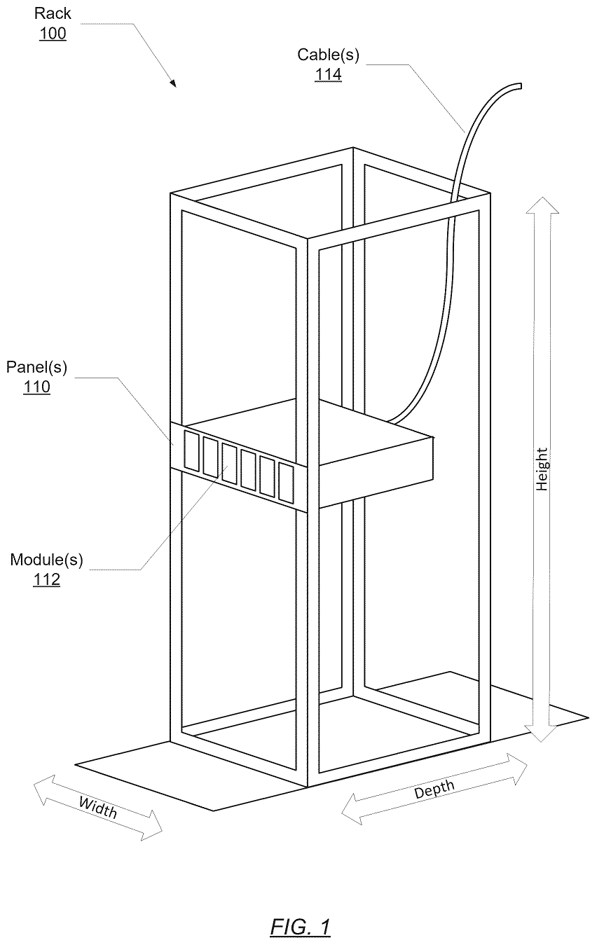

Turning to FIG. 1, a rack is shown in accordance with one or more embodiments. The rack (100) is a piece of telecommunications equipment that provides for the housing and organization of diverse telecommunication devices.

The outer dimensions of rack (100) conform with most network and server equipment. For example, rack width may measure 19 inches (48.26 cm) or 23 inches (58.42 cm) in width, standard measurements that are adhered to in the telecommunications industry. Other dimensions may be used, e.g., 21 inches, 23 inches, etc. The dimensions ensure that the rack can accommodate equipment with different form factors, such as 1 U, 2 U, or larger units, where “U” represents a standard rack unit of measure equal to 1.75 inches in height.

The rack (100) may include a series of uniformly spaced vertical mounting slots, located on both the front and rear, to facilitate the arrangement and mounting of various telecommunication devices and components. The slots serve as attachment points for mounting the panel(s) (110). The rack (100) may further be equipped with additional features such as ventilation openings and cable management.

Panel(s) (110) are components that mount within the rack (100) to organize, secure, and provide access to connective hardware. The panel may be constructed from materials such as steel or aluminum that can support the weight of the modules and withstand the physical demands of a data center environment.

Panel(s) (110) are formed with standardized form factors for compatibility with the mounting slots of the rack (100). For example, panel(s) (110) may include standardized mounting points to align with rack units, a layout that supports the intended cable or connector density, and provisions for labeling and user accessibility.

The panel(s) (110) may be equipped with one or more module(s) (112) to secure the fibers using ports, connector adapters, connectors, etc. Module(s) (112) are prefabricated units or sub-assemblies designed for quick installation into the rack (100). The module(s) (112) may include electronic components and/or optical components, such as optical connectors, optical fibers, switches, routers, or patches. The module(s) (112) may include features for splicing, cable management, and security.

Each module(s) (112) is designed to contain a specific number of optical connectors, optimizing space utilization within the rack mount to support high fiber densities. For example, each module(s) (112) may support fiber densities of 144 fibers, 288 fibers, and/or 576 fibers per module, as well as other suitable densities. The connectors may be an industry-standard connector such as a standard connector (SC), Lucent connector (LC), or Multi-fiber Termination Push-on connector (MTP), depending on the network requirements.

The module(s) (112) may have multiple widths, such that a varying number of modules may be housed within the panel(s) (110). The module(s) (112) may be sized to fit twelve (12) modules in the panel(s) (110), however other sizes—e.g., 2, 3, 4, 6, 8—are also contemplated. When fully loaded with module(s) (112), the panel(s) (110) support fiber densities of 1728 fibers, 3456, fibers, and/or 6912 fibers per panel, as well as other suitable densities.

Cable(s) (114) may be fiber optic cables that carry data signals between different network devices and components. Cable(s) (114) are routed through the data center infrastructure, connecting panels, modules, and external devices. For example, cable(s) (114) may interconnect module(s) (112). Cable(s) (114) may include a core, cladding, and protective coating, which ensure the integrity of the data signal. Cable(s) (114) can be single-mode or multi-mode, depending on the network requirements. Cable(s) (114) may be color-coded to facilitate identification during installation and maintenance.

Turning to FIG. 1, a rack is shown in accordance with one or more embodiments. The rack (100) is a piece of telecommunications equipment that provides for the housing and organization of diverse telecommunication devices.

The outer dimensions of rack (100) align most network and server equipment. For example, rack width may measure 19 inches (48.26 cm) or 23 inches (58.42 cm) in width, standard measurements that are adhered to in the telecommunications industry. Other dimensions may be used, e.g., 21 inches, 23 inches, etc. The dimensions ensure that the rack can accommodate equipment with different form factors, such as 1 U, 2 U, or larger units, where “U” represents a standard rack unit of measure equal to 1.75 inches in height.

The rack (100) may include a series of uniformly spaced vertical mounting slots, located on both the front and rear, to facilitate the arrangement and mounting of various telecommunication devices and components. The slots serve as attachment points for mounting the panel(s) (110). The rack (100) may further be equipped with additional features such as ventilation openings and cable management.

Panel(s) (110) are components that mount within the rack (100) to organize, secure, and provide access to connective hardware. The panel may be constructed from materials like steel or aluminum that can support the weight of the modules and withstand the physical demands of a data center environment.

Panel(s) (110) are formed with standardized form factors for compatibility with the mounting slots of the rack (100). For example, panel(s) (110) may include standardized mounting points to align with rack units, a layout that supports the intended cable or connector density, and provisions for labeling and user accessibility.

The panel(s) (110) may be equipped with one or more module(s) (112) to secure the fibers using ports, connector adapters, connectors, etc. Module(s) (112) are prefabricated units or sub-assemblies designed for quick installation into the rack (100). The module(s) (112) may include electronic components and/or optical components, such as optical connectors, optical fibers, switches, routers, or patches. The module(s) (112) may include features for splicing, cable management, and security.

Each module(s) (112) is designed to contain a specific number of optical connectors, optimizing space utilization within the rack mount to support high fiber densities. The connectors may be an industry-standard connector such as a standard connector (SC), Lucent connector (LC), or Multi-fiber Termination Push-on connector (MTP), depending on the network requirements. Each module(s) (112) may support fiber densities of 144 fibers per module, 288 fibers per module, and/or 576 fibers per module, as well as other suitable densities.

The module(s) (112) may have multiple widths, such that a varying number of modules may be housed within the panel(s) (110). The module(s) (112) may be sized to fit twelve (12) modules in the panel(s) (110), however other sizes—e.g., 2, 3, 4, 6, 8—are also contemplated. When fully loaded module(s) (112), the panel(s) (110) enable fiber densities per panel such as 1728 fibers, 3456, fibers, and/or 6912 fibers, as well as other suitable per panel densities.

Cable(s) (114) may be fiber optic cables that carry data signals between different network devices and components. Cable(s) (114) are routed through the data center infrastructure, connecting panels, modules, and external devices. For example, cable(s) (114) may interconnect module(s) (112). Cable(s) (114) may include a core, cladding, and protective coating, which ensure the integrity of the data signal. Cable(s) (114) can be single-mode or multi-mode, depending on the network requirements. Cable(s) (114) may be color-coded to facilitate identification during installation and maintenance.

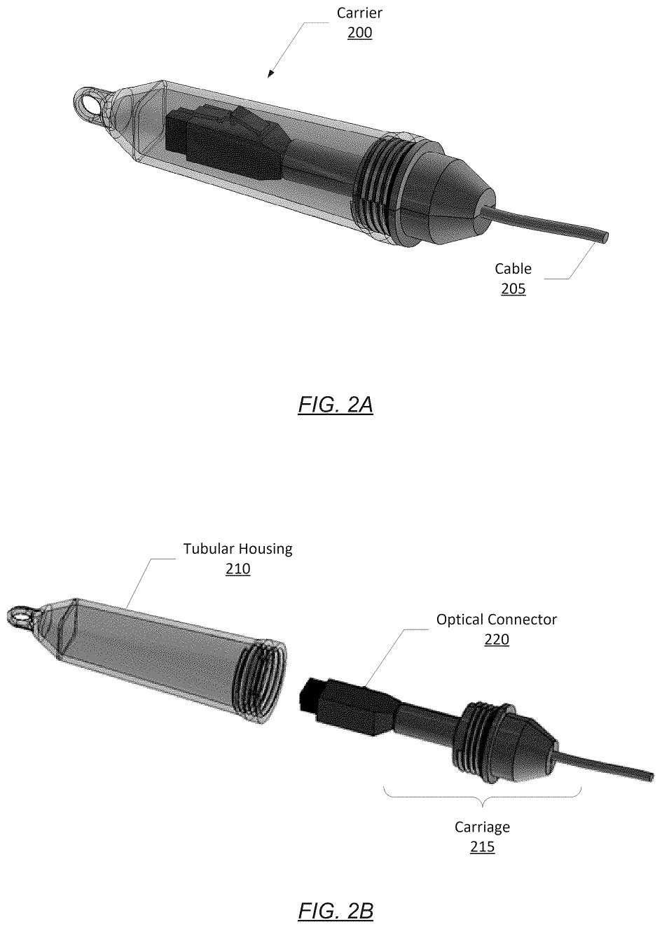

FIGS. 2A and 2B show a carrier (200) for pulling a cable (205), such as an optical cable terminated with an optical connector (220), through a conduit or buried pipe. The carrier (200) comprises a tubular housing (210) and a carriage (215), which together form an enclosure configured to receive, protect, and transport the optical connector (220) and the attached cable (205).

The term carrier refers to an assembly configured to enclose and protect an optical connector and associated cable during mechanical pulling. The carrier (200) includes a tubular housing (210) and a carriage (215) that is removably securable to a distal end of the housing. The housing (210) forms the primary enclosure body and is tubular, having an elongate shape with a varying cross-section. As shown, the housing (210) includes a first end that is tapered and a second end that is open to receive the carriage (215). The first end may be formed with a hemispherical cap and include an eyelet for mechanical attachment to a pulling device. The tubular housing (210) may be formed from molded polycarbonate or similar polymer suitable for high- strength and low-friction applications.

The tubular housing (210) defines an internal volume for receiving the optical connector (220). The housing has a non-uniform cross-section, which transitions from a circular geometry at the second end to a super-elliptic profile at an intermediate location between the ends. The shape modulation facilitates strain distribution and improves insertion characteristics during pulling. The modulation of the cross-sectional radius r1r_1 and r2r_2 may follow a parametric formulation, such as:

$${r}_{1} = {( {\vert \frac{sin θ + cos θ}{2 a} \vert}^{n} )}^{- \frac{1}{n}} \qquad Eq . 1$$

for the transition between the circular and super-elliptic region, and

$${r}_{2} = {( {\vert \frac{sin θ + cos θ}{\sqrt{2} a} \vert}^{n} )}^{- \frac{1}{n}} \qquad Eq . 2$$

for the taper toward the hemispherical cap, wherein:
a is the radius of the circular cross-section at the second end and
n is a shape-defining parameter in the range 1<n<2.

The carriage (215) is removably secured to the second end of the tubular housing (210). The carriage serves to retain and align the optical connector (220) and support the transition to the cable (205). The carriage (215) includes a plug component configured to seal the open end of the housing during pulling operations. The plug may take the form of a clamshell body with a longitudinal aperture extending therethrough. The aperture is dimensioned to hold the cable (205) and may include a diameter that is less than the outer diameter of the cable in at least one region to provide a sealing interface. The plug may further incorporate a snap-fit or hinged structure that enables it to be installed around the cable (205) without requiring disconnection of the connector (220).

The optical connector (220), as shown in FIG. 2B, is positioned within the housing (210). The connector may be an expanded beam optical (EBO) connector or other field-deployable connector such as SC, LC, or MPO. The connector terminates one end of the optical cable (205) and provides an optical interface for mating to a second connector in the field. The connector (220) is supported and aligned by the carriage (215), preventing movement during transport and protecting the connector ferrules and lenses.

The cable (205) is secured within the plug and extends outward from the carriage (215). The cable (205) includes one or more optical fibers surrounded by protective sheathing, and may be jacketed with polymer layers such as polyethylene or PVC, and may include strength members or water-blocking elements. The grommet surrounding the cable at the interface with the plug provides additional strain relief and environmental sealing.

In FIG. 2A, the assembled configuration is shown with the carriage (215) fully inserted into the tubular housing (210), and the optical connector (220) and cable (205) secured therein. In FIG. 2B, the carriage (215) is shown separated from the housing (210), with the connector (220) and cable (205) oriented for insertion. The threads on the second end of the housing (210) are visible and facilitate engagement with the carriage (215) to provide a releasable mechanical and sealing interface.

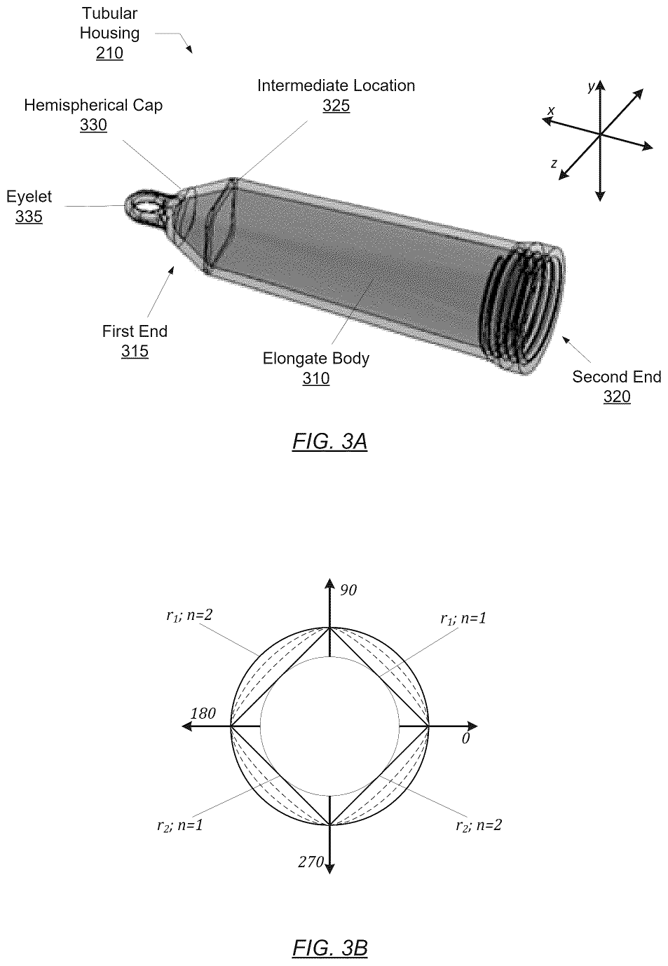

FIG. 3A shows a tubular housing (210) of the carrier assembly, according to one or more embodiments. The tubular housing (210) includes an elongate body (310) extending between a first end (315) and a second end (320) along a longitudinal axis. The elongate body (310) defines a non- uniform cross-section that varies along its length to modulate the structural profile of the housing. An intermediate location (325) is positioned between the first and second ends and demarcates a transition region in the cross-sectional geometry of the housing. The second end (320) is open and includes threaded features or mating interfaces to receive and secure a carriage assembly, as previously described in FIGS. 2A-2B.

The elongate body (310) is a structural tube that defines the internal cavity for receiving an optical connector and its associated cable. The elongate body (310) is characterized by a variable cross-section, where the shape transitions from a circular profile at the second end (320) to a super-elliptic profile at the intermediate location (325). The modulation of the cross-section can be achieved using a parametric surface defined as a function of angle θ and a shape parameter n, which is described in greater detail with respect to FIG. 3B. The elongate body (310) may be molded or extruded from polymeric materials such as polycarbonate, designed to withstand environmental and mechanical loads during deployment.

The first end (315) of the tubular housing (210) terminates in a hemispherical cap (330). The hemispherical cap (330) is integrally formed with or permanently affixed to the elongate body (310) and defines a rounded geometry to minimize resistance during pulling through a buried conduit. An eyelet (335) is affixed to or formed as part of the hemispherical cap (330). The eyelet (335) serves as an attachment point for a pull cable or other tensile member used to draw the carrier assembly through the conduit.

The second end (320) is axially opposite the first end (315) and forms an opening through which the carriage may be inserted or removed. The second end (320) may incorporate structural features such as threads, detents, or interference fits to secure the carriage. The carrier may be reversibly assembled by inserting the optical connector and carriage into the second end and subsequently sealing it with an end plug or grommet structure.

FIG. 3B shows a cross-sectional representation of the elongate body (310) taken along the YZ plane. The diagram illustrates a modulation of the cross-sectional geometry as a function of the angular coordinate θ . Multiple profiles are shown at selected angular intervals (e.g., 0°, 90°, (180)°, and) (270)° to compare different values of the shape parameter n. In the illustrated configuration, the radius r₁ for a circular cross-section corresponds to the profile where n=2, while the radius r₂ for a super-elliptic profile corresponds to the shape where n=1. The super-elliptic geometry, for 1<n<2, transitions smoothly between a square-like shape and a circle and may be defined by the parametric relations of Equations 1 and/or 2 above.

The modulation along the X-axis (axial direction) enables the housing to retain a compact profile near the carriage and a rounded profile at the first end, which aids in axial force distribution. Additionally, a rectangular or super-elliptic profile may additionally prevent unwanted movement of the optical connector during pulling.

The cross-sectional geometries illustrated in FIG. 3B provide structural reinforcement and strain relief at transitional areas along the housing. These shapes also aid in preventing rotation and torsional slippage of the internal connector, depending on application requirements. The super-elliptic geometry further enables smooth engagement with mating components and enhanced sealing integrity with the internal carriage.

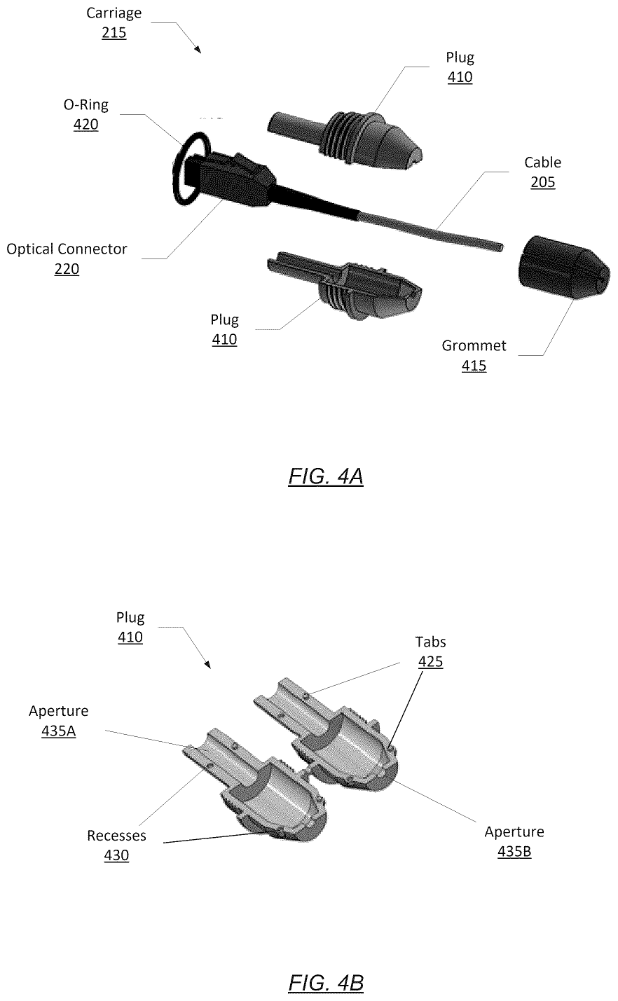

FIG. 4A illustrates an exploded view of the carriage (215), showing individual components including the optical connector (220), O-ring (420), plug (410), cable (205), and grommet (415). The carriage (215) is configured to be secured to the second end of the tubular housing and serves to mechanically retain and environmentally seal the optical connector (220) and cable (205) during pulling operations.

The carriage (215) refers to a structural assembly that supports the rear portion of the optical connector and transitions to the attached cable. The carriage includes a plug (410) which may be removably inserted into the second end of the tubular housing and is configured to seal the open end. The carriage also includes the optical connector (220) and sealing elements such as an O-ring (420) and a grommet (415).

The plug (410) is a multipart body that defines an internal aperture for receiving and securing the cable (205). As shown in FIG. 4A, the plug (410) may be implemented as a clamshell, formed from two symmetrical halves that can be joined around the cable. This configuration permits post-termination assembly and supports snap-fit engagement. The plug may include threaded, ribbed, or contoured outer surfaces that engage the interior of the tubular housing to form a press-fit or threaded seal. The plug (410) also contributes to axial strain relief for the cable and houses an interface for receiving the O-ring (420).

The O-ring (420) is an annular elastomeric seal placed between the outer surface of the plug (410) and the inner surface of the tubular housing. The O-ring (420) is configured to compress radially during insertion of the carriage, thereby forming a watertight seal. Suitable materials for the O-ring include silicone, rubber, or fluorocarbon elastomers. The O-ring ensures that moisture or debris does not ingress into the housing cavity, thereby protecting the optical connector during burial or conduit pulling.

The optical connector (220) is configured to terminate one or more optical fibers within the cable (205). The connector (220) may be implemented as an expanded beam optical (EBO) connector, or may include other optical connector formats such as LC, SC, or MPO depending on system requirements. The connector body is partially enclosed by the plug (410), and axially retained against displacement within the carriage assembly.

The cable (205) extends from the rear of the optical connector (220) and exits the plug (410) through an aperture. The cable includes an optical core protected by one or more sheathing layers, and may include strength members or jackets. The cable interface with the plug may be dimensioned such that at least one segment of the aperture has a diameter smaller than the outer diameter of the cable, resulting in a compression fit.

The grommet (415) is a flexible strain relief component configured to slide over the rear segment of the plug (410) and engage the outer jacket of the cable (205). The grommet may be formed of soft durometer silicone or rubber and provides abrasion resistance and additional sealing at the cable exit point.

FIG. 4B shows the two halves of the plug (410) in an open configuration, highlighting the internal geometry that facilitates snap-fit assembly around the cable. Each half includes an internal semi-cylindrical aperture—aperture (435A) and aperture (435B)—which together define a full cylindrical passage when the halves are closed. Portions of the aperture may be undercut to produce a compression zone for gripping the cable. The plug includes a plurality of tabs (425) that extend radially outward from the body and are configured to engage complementary recesses or detents in the housing or mating component. These tabs (425) allow for a secure snap engagement when the plug is inserted into the tubular housing.

The recesses (430) are shaped cavities formed into the mating surfaces of the plug halves. These recesses may be configured to align with the tabs (425) and lock the two halves of the plug together, maintaining axial alignment and resisting separation under tension. The recesses (430) may also assist in aligning the plug during the snap-fit process.

The apertures (435A) and (435B) define the through-channel for the cable and may be contoured to accommodate variations in cable geometry or outer sheath thickness. In some embodiments, the aperture includes stepped or tapered diameters to engage specific cable segments with different compressive forces, optimizing both strain relief and sealing performance.

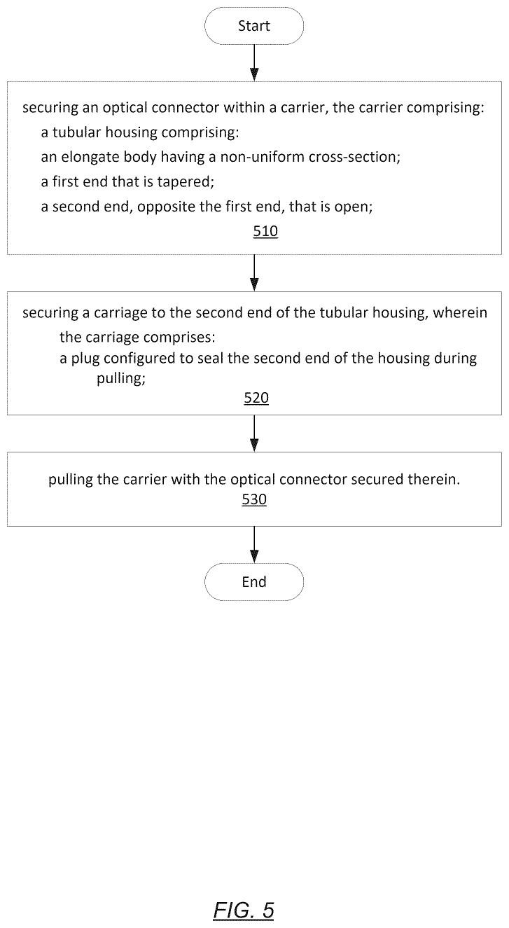

FIG. 5 illustrates a flowchart for a method of pulling an optical cable using a carrier, consistent with method claims 16 through 20. The method comprises securing an optical connector within a carrier, assembling the carriage onto the tubular housing, and performing a pulling operation with the assembled device.

At step (510), the method includes securing an optical connector within a carrier. The carrier includes a tubular housing having an elongate body with a non-uniform cross-section. The housing is characterized by a tapered first end and an open second end. The non-uniform cross-section may include a circular cross-section near the second end and a super-elliptic cross-section at an intermediate location along the body. An optical connector, such as an EBO connector, is inserted into the tubular housing such that the connector remains fully enclosed within the internal cavity. The cable extending from the connector exits the housing through the second end. This step ensures that the connector is housed within a sealed and mechanically protected volume suitable for underground or conduit-based deployment.

At step (520), the method includes securing a carriage to the second end of the tubular housing. The carriage comprises a plug configured to seal the open second end during pulling. The plug may be a clamshell that opens and closes around the optical cable and includes a through-aperture dimensioned to grip the outer surface of the cable. At least a portion of the aperture has a diameter less than the cable diameter to provide a compression seal. The plug may further include snap-fit tabs that engage the housing and resist axial displacement. A grommet may be fitted over the plug to provide strain relief and additional sealing. An O-ring may also be installed between the plug and housing to ensure watertight integrity during the pulling operation.

At step (530), the method proceeds with pulling the assembled carrier through a conduit or buried environment with the optical connector secured therein. A tensile member, such as a rope or steel wire, may be attached to an eyelet extending from the hemispherical cap located at the tapered first end of the housing. Pulling force is applied to the eyelet, which transmits the load through the housing and carriage while maintaining the internal connector and cable in a protected state. The geometry of the housing, including its tapered and super-elliptic profile, minimizes resistance and supports smooth translation during deployment.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, “or” is an “inclusive or” and, as such includes “and.” Further, items joined by an or may include any combination of the items with any number of each item unless expressly stated otherwise.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of keyword extraction using tags and n-grams. The various elements, systems, components, and steps shown in the figures may be omitted, repeated, combined, and/or altered as shown from the figures. Accordingly, the scope of the present disclosure should not be considered limited to the specific arrangements shown in the figures.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. A carrier for pulling a cable, the carrier comprising:
a tubular housing comprising:
an elongate body having a non-uniform cross-section, wherein the elongate body is configured to hold an optical connector;
a first end that is tapered;
a second end, opposite the first end, that is open; and
a carriage, releasably securable to the second end of the tubular housing, wherein the carriage comprises:
a plug configured to seal the second end of the housing during pulling.

2. The carrier of claim 1, wherein the non-uniform cross-section of the elongate body further comprises:
a circular cross section at the second end;
a super-elliptic cross-section at an intermediate location between the first end and the second end.

3. The carrier of claim 2, wherein the non-uniform cross-section is modulated between the second end and the intermediate location according to:
$${r}_{1} = {( {\vert \frac{sin θ + cos θ}{2 a} \vert}^{n} )}^{- \frac{1}{n}}$$
a=radius of the circular cross section at the second end; and
n is a positive parameter that defines a shape of the cross section, wherein 1<n<2.

4. The carrier of claim 3, wherein the non-uniform cross-section is modulated between the intermediate location and the first end according to:
$${r}_{2} = {( {\vert \frac{sin θ + cos θ}{\sqrt{2} a} \vert}^{n} )}^{- \frac{1}{n}}$$
a=radius of the circular cross section at the second end; and
n is a positive parameter that defines the shape of the cross section, wherein 1<n<2.

5. The carrier of claim 1, wherein the first end further comprises:
a hemispherical cap.

6. The carrier of claim 5, wherein the first end further comprises:
an eyelet extending from the hemispherical cap.

7. The carrier of claim 1, wherein the carriage further comprises:
a grommet configured to fit over at least a portion of the plug.

8. The carrier of claim 1, wherein the plug is a clamshell that can be snap fit around a cable of the optical connector.

9. The carrier of claim 1, wherein the plug further comprises:
an aperture extending through the plug and configured to hold a cable of the optical connector.

10. The carrier of claim 9, wherein the at least a portion of the aperture has a diameter that is less than a diameter of the cable.

11. An apparatus comprising:
an optical connector having a cable extending therefrom; and
a carrier comprising:
a tubular housing comprising:
an elongate body having a non-uniform cross-section, wherein the elongate body is configured to hold an optical connector;
a first end that is tapered;
a second end, opposite the first end, that is open; and
a carriage, releasably securable to the second end of the tubular housing,
wherein the carriage comprises:
a plug configured to seal the second end of the housing during pulling.

12. The apparatus of claim 11, wherein the non-uniform cross-section of the elongate body further comprises:
a circular cross section at the second end;
a super-elliptic cross-section at an intermediate location between the first end and the second end.

13. The apparatus of claim 11, wherein the first end further comprises:
a hemispherical cap; and
an eyelet extending from the hemispherical cap.

14. The apparatus of claim 11, wherein the carriage further comprises:
a grommet configured to fit over at least a portion of the plug.

15. The apparatus of claim 11, wherein the plug is a clamshell that can be snap fit around the cable of the optical connector, wherein the plug further comprises:
an aperture extending through the plug and configured to hold a cable of the optical connector wherein the at least a portion of the aperture has a diameter that is less than a diameter of the cable.

16. A method for pulling cable, the method comprising:
securing an optical connector within a carrier, the carrier comprising:
a tubular housing comprising:
an elongate body having a non-uniform cross-section;
a first end that is tapered;
a second end, opposite the first end, that is open;
securing a carriage to the second end of the tubular housing, wherein the carriage comprises:
a plug configured to seal the second end of the housing during pulling; and
pulling the carrier with the optical connector secured therein.

17. The method of claim 16, wherein the non-uniform cross-section of the elongate body further comprises:
a circular cross section at the second end;
a super-elliptic cross-section at an intermediate location between the first end and the second end.

18. The method of claim 16, wherein securing the carriage to the second end of the tubular housing further comprises:
fitting a grommet over at least a portion of the plug.

19. The method of claim 16, wherein the plug is a clamshell, and securing the optical connector within a carrier further comprising:
positioning the cable within an aperture extending through the plug, wherein the at least a portion of the aperture has a diameter that is less than a diameter of the cable; and
snap fitting the plug around the cable of the optical connector.

20. The method of claim 16, wherein the first end further comprises a hemispherical cap having an eyelet extending from the hemispherical cap, the method further comprising:
securing a pull cable to the eyelet; and
pulling the carrier via the pull cable.
